(19) United States
(12) Patent Application Publication
(10) Pub. No.: US 2020/0329692 A1
(43) Pub. Date: Oct. 22, 2020

(54) RODENT TRAP WITH ENHANCED ATTRACTANTS

(71) Applicant: AP&G Co. Inc., Bayonne, NJ (US)

(72) Inventor: Edward William Dolshun, Warwick, NY (US)

(21) Appl. No.: 16/853,559

(22) Filed: Apr. 21, 2020

Related U.S. Application Data
(60) Provisional application No. 62/836,214, filed on Apr. 19, 2019.

(51) Int. Cl. A01M 23/30

(52) U.S. Cl. CPC A01M 23/30

(57) ABSTRACT

A rodent having elements that are visually attractive to rodents. The trap incorporates nesting material, which is attractive to female mice. The trap may also include one or more stalk-like elements which are visually attractive to mice.

### RELATED APPLICATIONS

This Application claims the benefit of pending U.S. Provisional Appl. 62/836,214 filed Apr. 19, 2019, the contents of which are fully incorporated by reference herein.

### FIELD OF THE INVENTION

The invention relates to the field of rodent abatement devices, more specifically to a rodent trap having enhanced attractants features to attract rodents.

### BACKGROUND OF THE INVENTION

Rodent traps are routinely used in residential and commercial settings. Commonly used trapping devices include mechanical traps and glue boards. One problem associated with rodent traps is that bait may not last in the trap a sufficient amount of time to attract a rodent. In addition, although bait used in current traps may be pleasing to a rodent's olfactory senses, they are nevertheless often not visually appealing.

Mice are known to build nests within homes. Most often, they construct nests by scavenging for materials that are available within their environment. To that end, mice may use paper, fabric, string, insulation, batting from cushions and similar fabric materials for nest components. Female mice typically search for such materials in order to build a nest for their expected young.

### SUMMARY OF THE INVENTION

The invention set forth herein is a rodent trap that contains elements that are visually appealing to a rodent. In other embodiments, the trap is provided with elements that are necessary for a female mouse to build a nest.

For example, in embodiments of the invention, a rodent trap is provided with nesting material, such as cotton or other textile, batting, fabric, fibrous material or similar material. A female rodent scavenging for nesting materials will be attracted to such material disposed in the trap.

In other embodiments of the invention, a rodent trap is provided with a stalk-like member that extends upward from the trap. Such, thin elongated vertical elements are appealing to mice and similar rodents that are accustomed to living in fields where stalks grow.

In embodiments of the invention, a trap may be provided with at least two attractants, such as a stalk-like member plus bait or nesting material plus bait. In embodiments of the invention, a trap may be provided with a stalk-like member, nesting material, and bait. Still in other embodiments a bait plug comprising a synthetic attractant is formed with a pocket that is configured to receive nesting material or other food attractants.

### BRIEF DESCRIPTION OF THE DRAWINGS

FIG. 1 is top perspective view of a rodent trap provided with nesting materials shown in a set position according to an embodiment of the invention.

FIG. 2 is a top perspective view of the rodent trap of FIG. 1 shown in a deployed position according to an embodiment of the invention.

FIG. 3 is a top perspective view of a rodent trap having a stalk-like element according to an embodiment of the invention.

FIG. 4A is a top view of a bait cup having a dividing wall to form two individual compartments in accordance with an embodiment of the invention.

FIG. 4B is a top view of a bait cup having a two concentric circular wall to form two individual compartments in accordance with an embodiment of the invention.

FIG. 5 is a side perspective view of a bait plug configured to receive nesting material in accordance with an embodiment of the invention.

FIG. 6 is a side cross-sectional view through a bait plug according to an embodiment of the invention.

FIG. 7 is a side perspective view of a rodent trap with the bait plug of FIG. 5 seated therein.

FIG. 8 shows the rodent trap of FIG. 7 with nesting material provided within a pocket disposed on bait plug according to an embodiment of the invention.

### DETAILED DESCRIPTION OF THE INVENTION

The following is a detailed description of the preferred embodiments of the invention, reference being made to the drawings in which the same reference numerals identify the same elements of structure in each of the several figures. It should be noted that these drawings are merely exemplary in nature and in no way serve to limit the scope of the invention.

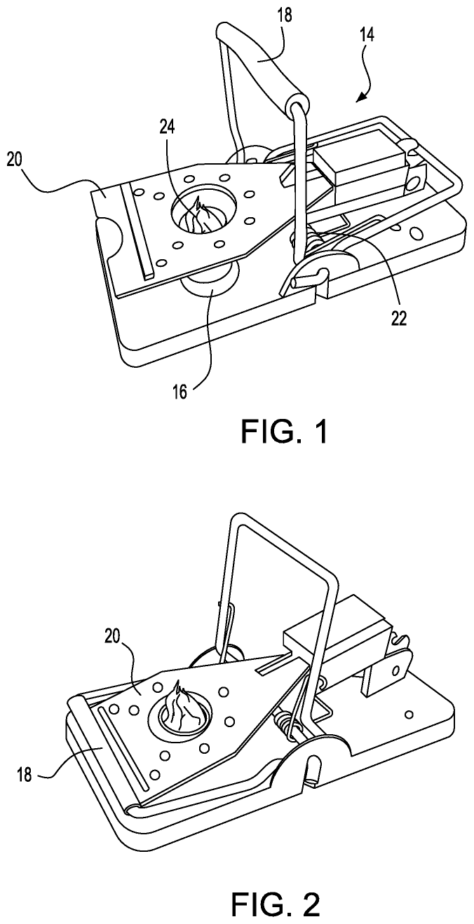

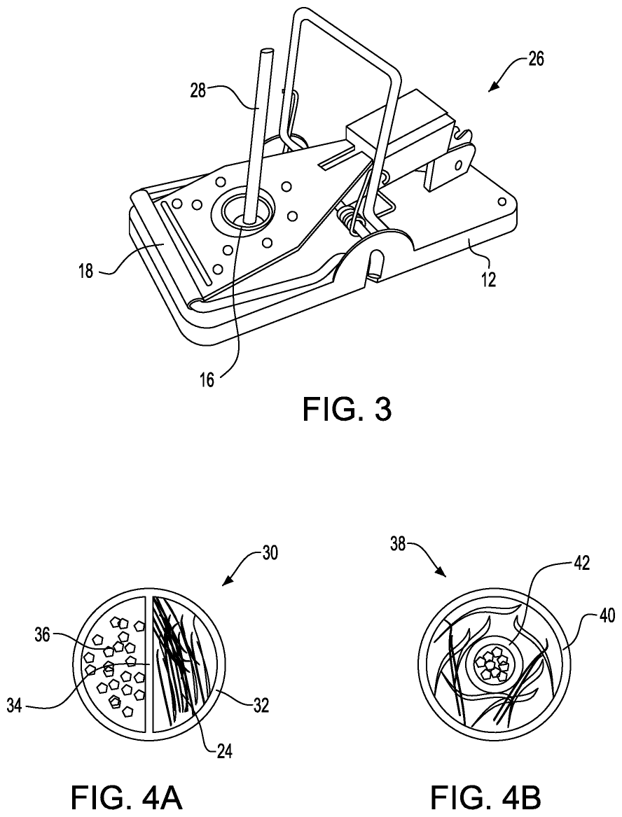

Referring to FIG. 1, a mechanical rodent trap 10 is shown. Trap 10 may be similar to any of various mechanical rodent traps which are known in the art. As shown, trap 10 is provided with a base member 12 which supports spring-loaded snap mechanism 14 and a bait cup 16. The snap mechanism 14 includes a bar 18 that is maintained in a raised position when the trap 10 is set. A trigger plate 20, mechanically linked to bar 18, is positioned to hold the bar 18 in a raised position. When trigger plate 20 is moved, bar 18 is forcefully driven downward by a spring 22.

As shown, bait cup 16 is positioned below trigger plate 20 such that a rodent attempting to eat the bait contained in the bait cup will need to contact the trigger plate and thereby cause the spring-biased bar 18 to be driven downward killing the rodent.

In embodiments of the invention, bait cup 16 is pre-loaded with cotton or similar fibrous nesting material 24. It will be understood that any of various materials such as string, yarn, fabric, textile or such similar materials may be used as attractive nesting materials in embodiments of the invention.

In embodiment of the invention, nesting material 24 is adhered (e.g. via glue) to the inner walls or the floor of bait cup 16. In such manner, a user may stretch the material 24 so that it extends through the hole of trigger plate 20. The nesting material 24 acts as visual attractant to a female rodent who may be scavenging for materials with which to construct a nest.

FIG. 2 shows trap 10 in a deployed position. As shown, trigger plate 20 has been triggered by a rodent, and as a result, bar 18 has been released and driven downward.

In embodiments of the invention, a trap 26 is provided with a stalk-like member. Trap 26 may be any of various mechanical rodent traps, for example, as set forth above with respect to FIGS. 1 and 2. As shown, a stalk-like member 28 extends upwardly from base member 12. Stalk-like member 28 may be any of various slender structures that may mimic a stalk or similar plant part. Stalk-like member 28 may be a wire, a rubber tube, a plastic tube or any such similar elongated structure. Preferably, stalk-like member 28 is formed of a material that has sufficient rigidity to remain vertical. In embodiments, the upright member emanating from the trap appears like a blade of grass or similar stalk, which are naturally attractive to mice.

It will be understood that stalk-like member 28 may emanate from the bait cup 16. In embodiments, a bait cup 16 from which stalk-like member 28 extends, also has sufficient area to receive bait. For example, if stalk-like member 28 is positioned in the general center of bait cup 16, bait may nonetheless be deposited into the bait cup 16 in the areas surrounding the stalk-like member 28.

In embodiments of the invention, and with reference to FIGS. 4A and 4B, bait cups in accordance with embodiments of the invention are configured to contain both food/chemical attractant as well as nesting material. For example, FIG. 4A shows a top view of a bait cup 30, having a circular wall 32 and a dividing wall 34—thus forming two separate compartments. In embodiments of the invention, a first compartment is configured to receive nesting material 24 and a second compartment is configured to receive other bait material 36, such as peanut butter, synthetic scent materials or the like.

With further reference to FIG. 4A, a device may be sold with nesting material that is already adhered to the first compartment. The second compartment may be left open for users to insert their own bait. In other embodiments of the invention, however, the second compartment is pre-filled with synthetic scent materials.

FIG. 4B shows a top view of bait cup 38 in accordance with another embodiment of the invention. As shown, bait cup 38 is formed of an outer circular wall 40 and a second circular wall 42 disposed within the confines of outer circular wall 40. A first (outer) compartment is thus formed between walls 40 and 42 and a second (inner) compartment is formed within wall 42. In embodiments of the invention, the first compartment is configured to receive nesting material, and the second compartment is configured to receive other bait substances 36, such as peanut butter, synthetic scent materials and/or a stalk-like structure as described.

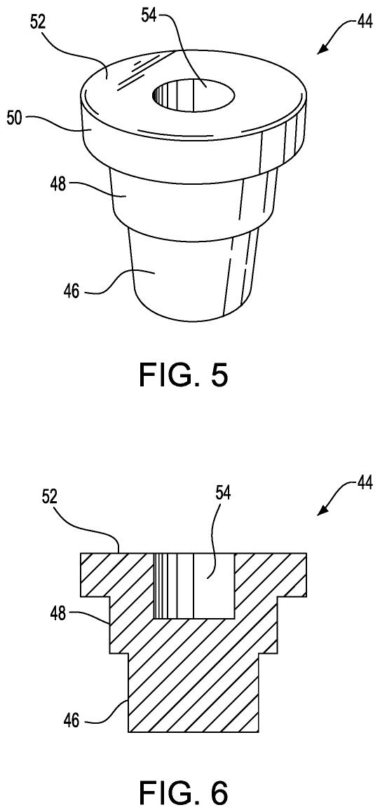

In other embodiments of the invention, a bait plug configured to receive nesting material is used to attract mice or other rodents. For example, with reference to FIG. 5, a plug 44 is shown having a lower most cylindrical segment 46, a middle cylindrical segment 48 and an upper disc member 50. Disc member has an upper face 52 and a surrounding edge. It will be understood that as an alternative to upper disc member 50, the upper segment of bait plug 44 may be formed in any of various shapes, such as but not limited to, square, rectangle, star, hexagon etc. As shown, in embodiments of the invention, a cutout is made in upper face 52 of upper disc member 50 to form a pocket 54.

In embodiments of the invention, plug 44 is formed of plastic or such similar material and it is embedded with a scent that is attractive to a rodent. It will be understood that bait plug 44 may contain filing agents such, for example, wax. Any part of the bait plug 44 may be impregnated with or provided with a scented substance. Scented substance may be natural or synthetic in embodiments of the invention.

As shown in FIG. 6, in embodiments of the invention, pocket 54 traverses through upper disc member 50 and terminates in middle cylindrical segment 48. In other embodiments, pocket 54 traverses middle cylindrical segment 48 and inserts into lower cylindrical segment 46.

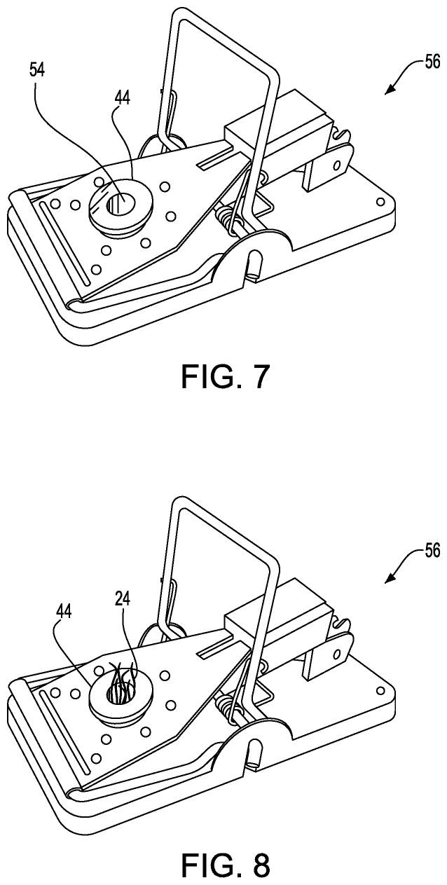

Lower cylindrical segment 46 is substantially sized and shaped to fit snugly within a bait cup (e.g. 16), such that inner walls of the bait cup contact and capture the lower cylindrical segment 46 of the bait plug 44. FIG. 7 shows bait plug 44 seated within a bait cup such that its upper disc member 50 is positioned below a trigger plate (when the trap is set).

In embodiments of the invention, the lower cylindrical segment 46 is tapered thus allowing the bait plug to be seated in bait cups of varying circumferences.

In embodiments of the invention, and as shown in FIG. 8, pocket 54 is configured to receive nesting material 24 such as cotton or similar fabric or textile material. In embodiments of the invention, the combination of olfactory and visual attractiveness increases the effectiveness of a rodent trap in accordance with an embodiment of the invention.

In use, a user may bait a trap in accordance with embodiments of the invention with conventional bait substances, and the user may optionally add nesting materials to increase attractiveness of the trap. In some cases, the user may need to gently tug on the nesting materials to stretch the same in order that they extend though the hole of a trigger plate (e.g. 20) of a rodent trap.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A rodent trap, comprising:
a snap mechanism configured to trap a rodent;
a trigger plate configured to selectively maintain the snap mechanism in a set position;
a bait cup configured to receive a bait plug;
a bait plug comprising a scented substance, the bait plug having an upper segment and a lower segment, whereby the lower segment is configured to be seated within the bait cup and the upper segment is configured to be positioned below the trigger plate;
a pocket formed in the upper segment of the bait plug that is configured to receive nesting material.

2) The rodent trap of claim 1, whereby the lower segment of the bait plug comprises a cylindrical segment.

3) rodent trap of claim 1, whereby the upper segment comprises a disc-shaped segment comprising an upper face and a surround edge, whereby the pocket is formed in the upper face.

4) rodent trap of claim 2, whereby the cylindrical segment is tapered.
